(19) United States
(12) Patent Application Publication
(10) Pub. No.: US 2009/0049095 A1
(43) Pub. Date: Feb. 19, 2009

(54) Internet based employment service transmitted using web services and video

(76) Inventors: Sigil Simon, Missouri City, TX (US); Benson Varghese, Sugarland, TX (US); Ebenson Abraham, Missouri City, TX (US); George Mathew, South Barrington, IL (US)

Correspondence Address: LAW OFFICE OF DAVID MCEWING, P.O. BOX 231324, HOUSTON, TX, 77023, US

(21) Appl. No.: 11/901,753

(22) Filed: Sep. 19, 2007

Related U.S. Application Data
(60) Provisional application No. 60/846,477, filed on Sep. 22, 2006.

(51) Int. Cl. G06F 17/30

(52) U.S. Cl. 707/104.1; 707/E17.032

(57) ABSTRACT

The invention comprises an Internet based employment information computer network comprising at least one server and a database that utilizes a web service software system for transmission of employment candidate information from the database to an employer network. In one embodiment, the network further comprising resumes, photos or videos entered on the network database by employment candidates. In another embodiment, a website may be linked to a computer network and comprise at least one server and a database containing employment related information of at least one candidate and the database is searchable from remote computers and each employment candidate has a personalized profile URL or email address to receive messages or questions.

### RELATED APPLICATION

This application claims priority to provisional application No. 60/846,477 entitled “Internet Based Employment Service Incorporating Web Services and Video” filed Sep. 22, 2006.

### 1. FIELD OF USE

The invention subject of this disclosure pertains to an Internet based website wherein prospective employees can post information of education and experience (hereinafter applications and resumes) for review by prospective employers. The website may also posts a photo of the prospective employee (hereinafter “candidate”). The website may also post a video of the candidate for review by an interested employer. The contents of the website or options which may be accessible, including accessible through web services software program system as defined herein, to an employer are video, photo, text resume, application, video conferencing, questionnaire, text messages, maps, travel accommodations, personalized URL, and past employer references.

The invention also pertains to employers seeking to hire candidates (hereinafter “employers”) by posting on an Internet website information of available employment positions. The information may include an Internet accessible video illustrating features of the employment such as work areas, co-workers or supervisors. The participants in the video may describe the work environment and desired attributes of a candidate. The content of the website applicable to the employer, or options accessible to a candidate include text messages, employer job video posting, video conferencing, questionnaire, receiving batches of applications and resumes transmitted through web services.

### 2. BACKGROUND OF INVENTION

The invention pertains to matching candidates to employers. Internet employment clearing houses currently exist such as Monster.com. Monster.com permits searching only of text resumes in the fields or formatting of Monster.com. Further, small business owners are unable to afford the price for the large minimum quantities of job candidates sold by Monster.com.

### BRIEF SUMMARY OF INVENTION

The invention comprises an Internet based employment information computer network comprising at least one server and a database that utilizes a web service software system for transmission of employment candidate information from the database to an employer network.

In one embodiment, the network further comprising applications, resumes, photos or videos entered on the network database by employment candidates.

### BRIEF SUMMARY OF DRAWINGS

The accompanying drawing, which is incorporated in and constitutes a part of the specification, illustrates a preferred embodiment of the invention.

This drawing, together with the general description of the invention given above and the detailed description of the preferred embodiments given below, serve to explain the principles of the invention.

FIG. 1 illustrates the relationship between a client (employer) network and a network providing requested employment candidate data from a server of the subject invention utilizing a web service.

### DESCRIPTION OF INVENTION

The invention permits the hiring process to be conducted through the Internet, commencing with the posting of applications and resumes by employment candidates, including selection of promising candidates by employers, submission of questions to selected candidates by the employer, video interviews of candidates (in real time), and new hire orientation.

In another embodiment, the candidate identity may be known and the site may serve as a social networking site wherein known jobs or job leads can be forwarded to listed candidates.

The invention includes, in one embodiment, utilization of web service systems. Although such systems are readily understood by persons skilled in the technology, web service programs can be defined as software programs running on computers connected to the Internet that can interoperate with programs on other computers using, for example, XML as a standard way of formatting data to be communicated. Software applications written in various programming languages and running on various platforms can use web services software systems to rapidly exchange data over computer networks like the Internet in a manner similar to inter-process communications on a single computer or any device accessible to the Internet.

The invention discloses a method and apparatus for exchanging information regarding candidates and employers. The data may be rapidly portable. For example, information of multiple candidates may be quickly transmitted to a client employer's site with the transmitted data being appropriately formatted within the employer's system. It will be appreciated that there is no data inputting to the employer's site.

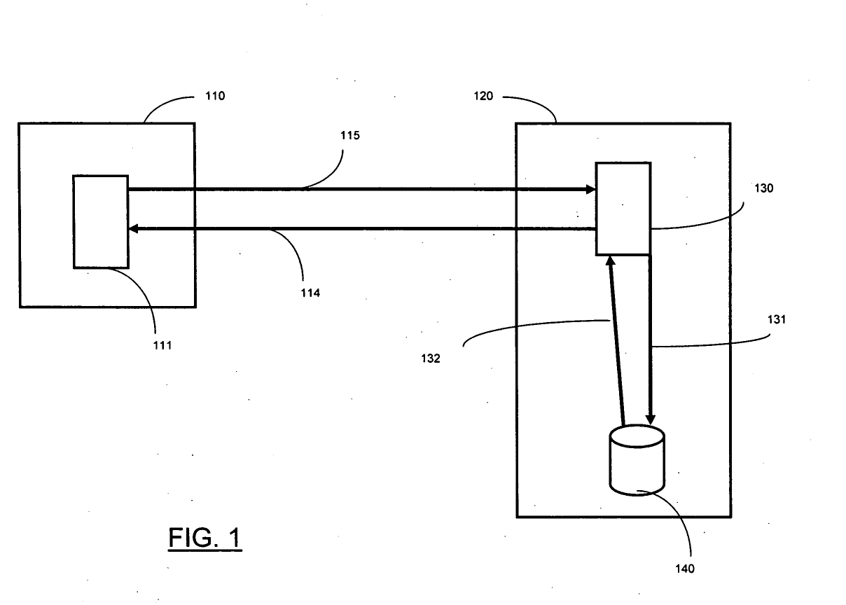

FIG. 1 illustrates the portability of data stored within the website subject 120 of the invention and a client employer network 110. An employer starts a search query from the employer network 110 by entering the search criteria for applications/resumes to be selected. The employer network includes an Application Workstation or Server 111 (for example MS InfoPath web applications). The Employer system may submit 115 the query via a SOAP Web Service request to the Search Application, Resume Web Service 130 of the instant invention. The Search Application, Resume Web Service and Search Database 140 are included in the network of the subject invention. The Search Application, Resume Web Service checks the employer user's security credentials. If they are valid, a request for the application/resume data is sent 131 to the database 140.

In the next step, the Search Database returns 132 the selected applications/resumes to the Search Application/Resume Web Service 130. The Application/Resume Web Service returns 114 the selected application/resume to the employer application. It will be appreciated that the submission 115 of the original query and the return 114 of selected resumes is through the Internet.

The employer application may perform some action with the applications/resumes. For example, it may display and/or process the applications/resumes.

In another embodiment, the invention includes utilization of the web service function of the website subject of the invention for searching through the Internet other employment databases and returning the results to employers appropriately formatted within the employer's system.

The server of the invention may also be utilized to rank employment candidates based upon varying criteria selected by the employer. For example, the employer may prioritize candidates graduating from certain universities or having worked at specified companies. In another example, it may search for employees within in specified age category.

The invention comprises an Internet accessible website. The website may be operated by a website administrator (hereinafter “administrator”). In one embodiment the website includes a database wherein information is submitted (hereinafter “posted”) by candidates. In one embodiment, the candidate information does not disclose name or contact information. An employer must go through the website of the invention to contact a candidate. Individual contact information may be stored on a separate database of the website.

In a further embodiment, the network subject of the invention assists candidates from the starting point of beginning the job search process to the first day the candidate begins working for an employer. This is a multi staged process beginning with posting a text resume on the website to ultimately learning the orientation procedures and expectations for a new hire. The following lists the multiple stages submitted with a brief description:

Applying for a Position Online

Candidate(s) can post a text resume/application to the website with a photo and/or a brief video clip of the candidate talking about their qualifications and skills.

Resumes Viewed by Prospective Employers

At this stage, the employer views the application/resume (possibly at the website) and determines if the candidate(s) qualification meets the company standards for the position which the candidate(s) is applying for.

The website may use a web service software system to transmit the candidate(s) data to the employer's network, i.e., text, photo, video, questionnaires, etc. This highly benefits the employer because it makes viewing applications/resumes convenient from a time, efficiency, and an organizational standpoint. The candidate information may be formatted onto the employer's system and becomes part of the employer's database.

1^{st} Online Interview by the Employer

In situations where the traditional face to face interview is chosen based upon review of text resume/applications, the website may facilitate the meeting.

Utilizing the website subject of the invention, the employer can communicate on line with the candidate. The methods of communication may vary. In one embodiment, the candidate is interviewed utilizing timed questionnaires. For example, the questionnaires are pre-set or live in format which the employer will determine. The employer can have a set list of questions or a multiple lists of questions where the questions are sent at random to candidate(s) so others will not get the same questions.

While the candidate(s) is taking the online interview, they have a set time period to get through these questions i.e. recreating the setting of an actual real-time interview online. At the same time, the employer has the ability to see the candidate answering questions i.e. through text, VOIP, or tele-conferencing over the video and phone. This is feasible by using webcams initially by both the candidate(s) and the employer.

Candidate(s) Gets Asked to have a 2^{nd} or 3^{rd} Interview by the Employer

This stage is usually when the employer asks the candidate to make a corporate or campus visit if the candidate(s) has not already done so. Some employers could skip this step depending if they have the budget to bring the candidate(s). Otherwise, they could re-simulate the campus visit through the website by taking video of site and transmitting it back to the website for the candidate(s) to see. Also, if they have any further questions or tests for the candidate(s) it could be achieved through the questionnaire format using web service to the website accessible to the candidate.

If the candidate(s) does make the visit to the employers facility, the candidate(s) could coordinate with employer in regards to travel and accommodation needs through the website using web service or mash-ups.

Employer will hire the candidate(s) or start the whole hiring process again.

Just as the title describes this section, if the candidate(s) is hired, then they could be asked to go to the website to view training online for orientation and what the candidate should bring on the first day of work, etc.

The above mentioned stages are the process that candidates go through in finding a specific job through the website subject of the invention. Candidate(s) could find jobs for full-time, part-time, or contract (seasonal) jobs at any level in their career i.e. high school, studying in college, graduated from college, or looking for another job in their prime working years. Also, the reverse is possible for the employers looking for candidate(s) to fill vacant positions i.e. full-time, part-time, or contract (like a staffing agency).

As discussed in the preceding paragraphs, the posted information that is accessible to potential employers can comprise text information regarding the candidate. This information may be typical information contained in resumes such as candidate education, job experience and employment history. The text information can be inputted in various formats such as Microsoft Word. The text information can be “cut and pasted” from another document. The information may also include recommendations concerning the candidate authored by third parties such as former employers, teachers, etc.

In one embodiment, the candidate may submit an “abstract” of personal information or qualifications that may be of limited length. This may be in addition to a standard resume of education, etc. Such an abstract may be requested by the website. The abstract may intended to contain selected key words deemed responsive to a search engine of an employer or others.

In another embodiment, the candidate may post a video with audio wherein the candidate provides a personal image and audio presentation of the candidate's qualifications or employment goals. The video may be uploaded to the website by the candidate from the candidate's computer using commercially available software and hardware. For example, the video may be played utilizing Real Player or Microsoft Media Player. In one embodiment the video is 4 MB.

The candidate may also post an individual photo.

It will be appreciated that the website may have protocols or format restrictions upon uploads, i.e., photos may be jpeg and of minimal pixel and dpi size.

In one embodiment, the site administrator will monitor content for conformance with website formatting. This formatting may include adaptability of website content to an application programming interface. For example, it may be intended that the website of the invention permit the content (applications, resumes, photos, video content) to be portable through a web service. Software applications written in various programming languages and running on various platforms can use web services to exchange data over computer networks like the Internet in a manner similar to inter-process communications on a single computer. For example, all content may be required to be of a certain protocol or group of protocols such as HTTP and SMTP. In this manner, information on the website may be ported to an employer site or portal.

The employer may be charged a fee for each candidate resume or data file accessed and/or downloaded (or “ported” via a web service).

As an example of the portability feature of the website, the employer site may submit the query via a SOAP Web Service request to the subject website Application/Resume Web Service. The Search Application/Resume Web Service checks the user's (employer's) security credential. If the credentials are valid, a request for the application/resume data is sent to the database. The database returns the selected applications/resumes to the Search Application/Resume Web Service. The Search Application/Resume Web Service returns the selected resumes to the employer applications. The employer application performs some actions with the resumes. For example, it may display and/or process the resumes.

Transferred files may be incorporated into the employer's site with the data content compatible with the employer's site, thereby eliminating a data entry step.

In one embodiment, the employer may access the website (or import the website content to their own site) and review the all or selected portions of text information of candidates. In as much as the data files do not contain candidate contact information, each candidate will have a unique identifier assigned by the website administrator. In one example, the identifier comprises a primary key assigned by the website.

The employer may therefore utilize the website or administrator to initiate contact with an individual candidate or a group of candidates. Additional information regarding the candidates can be supplied via the website.

Contact may be made through the website using an email address assigned by the administrator and unique to the candidate. The employer may be charged a fee for each email.

The employer may conduct a “telephone” interview of a candidate through the website using Voice over IP Technology.

In another embodiment, each candidate may have a personalized profile URL and containing the text application/resume and video resume.

In another embodiment, the candidate text information is electronically stored in a searchable database. Employers may make requests for candidate information based upon employer selected key words which may be contained within the text information of one or more candidates. This search criteria may be in addition to searching by candidate supplied information of employment position sought by the candidate. This search criteria may also be in addition to geographic information supplied by candidates.

This search methodology does not restrict the employer from searching candidate categorized as accountants. The employer may search all candidates that may have the word accounting within their database.

In one embodiment of the invention, the database of candidate information may be searched by natural language (without artificial syntax and terms involved with computer languages).

In one embodiment, the questions may be submitted in text format to the candidates. This information/questionnaire may be submitted to the website from the employer utilizing a web service. The candidate may elect to participate in answering the questions through the website. The candidate may have a limited time period to answer each question. For example, a hypothetical question may be asked of the candidate. The candidate may be given a specified period of time to provide a response to the question. The response may be furnished in text form. In another example, the answer may be given orally via telephone or computer/Internet connection such as Voice over IP. In yet another embodiment, the response may be provided or recorded by video.

It will be appreciated that the employer is receiving supplemental information from the candidate without having to invest the time or expense of arranging a “face to face” interview. More rapid screening of candidates can be accomplished. Portability of data allows placement of candidate information into the employer's format for review and evaluation without data entry. There is a similar savings of time on the part of candidates. It will be appreciated that the candidates are not required to participate in this process.

In another embodiment, employers may post information regarding open positions with the Internet website subject of the invention. This information can include text information of the job description and desired qualifications of candidates. The employers may be charged a fee for posting text information on the website accessible to candidates.

In another embodiment, the employer may also post a video with audio accessible through the website to candidates. The employer may be charged a fee for posting the video. In one embodiment, the video content is selected by the employer. For example, the video may show the work environment applicable to the advertised employment position. It may be a video of the job supervisor describing the work environment and desired attributes for a successful candidate. It will be appreciated that this step may create a group of candidates for interview that are more closely matched with the specific employment position and work environment.

The invention subject of this application includes an Internet website having the capabilities to send and receive email, send and receive text (e.g., applications, resumes and job descriptions) and the ability to send and receive photo images and video and audio (preferably by a web service software system). The invention also includes the ability of a user, e.g., candidate, to review postings of available job openings and employer information. The invention may also include the ability of an employer to review limited information of job candidates and request full details to be electronically provided. There may be functionality for the employer to pay fees electronically for the downloaded information. In one embodiment, this website comprises the following components: a server, at least one CPU, memory, a buffer, etc.

In another embodiment of the invention, the website provides a portal for local employers to create an employment listing tailored for available local candidates. For example, employers can select candidates having qualifications closely matching the employer's needs, in contrast to receiving an unscreened listing of candidates expressing interest with positions in the geographic area. The employer only pays a fee for receiving expanded information for the specific candidates selected.

What we claim is:

1. An Internet-based employment information computer network comprising at least one server and a database that utilizes a Web Service software system for transmission of employment candidate information from the database to an employer network via the Internet.

2. The network of claim 1 further comprising applications, resumes, photos or videos entered on the network database by employment candidates.

3. A website linked to the Internet and comprising at least one server and a database containing employment related information of at least one candidate and the database is searchable from remote computers.

4. The website of claim 3 wherein each employment candidate is assigned a unique identifier that may be used to contact the candidate through the website.

5. The website of claim 3 wherein the candidate is assigned a personal identifier allowing an employer to contact an employee candidate directly.

6. The website of claim 3 wherein the candidate's name, address, or email address is not within the database accessible by employers.

7. The website of claim 3 wherein text questions may be communicated by an employer to a candidate through the website.

8. The website of claim 7 wherein the candidate is provided limited time to respond to the text questions.

9. The website of claim 3 wherein an employment candidate can be accessed by Voice over IP technology.

10. The website of claim 3 wherein the employment candidate can be accessed by audio and video technology.

11. The website of claim 3 wherein the employment related information of an employment candidate includes a photo or video accessible from a remote computer.

12. A method of evaluating candidates for employment comprising the steps of: accessing a website containing a database of candidates; conducting a search of the database using employer selected search criteria; reviewing data of at least one candidate.

13. The method of claim 12 further comprising sending data from the database to an employer network using a web service software system.

14. The method of claim 12 further comprising submitting a text message to at least one candidate.

15. The method of claim 14 wherein the text message includes questions.

16. The method of claim 12 further comprising communicating with at least one candidate by Voice over IP technology.

17. The method of claim 12 further comprising viewing a video of at least one candidate.

18. A method of reviewing employment candidates wherein the employer pays a fee for accessing data within a database for a candidate.

19. The method of claim 18 further comprising the employer paying a fee for submitting a message to an employment candidate.

20. A first server and a first database connected to a computer network wherein data of candidates contained in the first database may be accessed from a remote server utilizing a web service software system and downloaded to a second database of a remote server wherein an application program interface of the first server allows the data to be communicated to another computer program.
